(19) United States
(12) Patent Application Publication
(10) Pub. No.: US 2020/0118151 A1
(43) Pub. Date: Apr. 16, 2020

(54) SYSTEM AND METHOD FOR PROVIDING INCENTIVES FOR DATA TRANSFER FROM VEHICLE

(71) Applicant: FORD GLOBAL TECHNOLOGIES, LLC, Dearborn, MI (US)

(72) Inventors: Omar MAKKE, Lyon Township, MI (US); Oleg Yurievitch GUSIKHIN, Commerce Township, MI (US)

(21) Appl. No.: 16/156,498

(22) Filed: Oct. 10, 2018

(51) Int. Cl. G06Q 30/02

(52) U.S. Cl. CPC G06Q 30/0215; G06Q 30/0283

(57) ABSTRACT

A vehicle includes a communication channel administered by a vehicle manufacturer and a communication channel administered by a vehicle owner. The vehicle includes a controller programmed to transfer manufacturer data over the vehicle-owner administrated communication channel, accumulate a count indicative of an amount of manufacturer data transferred over the vehicle-owner administrated communication channel, generate an incentive amount based on the count, and, responsive to a redemption request, transfer the incentive amount for redemption.

### TECHNICAL FIELD

This application generally relates to systems and methods for transferring data from vehicles.

### BACKGROUND

Vehicles include network connectivity features for transferring data between the vehicle and a remote network. The data transfer includes vehicle data and statistics that are useful to the manufacturer. The data transfer can also include data used by the vehicle owner or operator. The network connectivity may be over a cellular network for which cost is incurred by either the manufacturer or the vehicle owner. Cellular network connectivity often requires a subscription or periodic payments to maintain connectivity. Manufacturers may provide a free subscription period to the vehicle owner for using a manufacturer arranged communication channel. However, many vehicle owners opt out of the subscription after the free trial period expires. If the manufacturer wishes to retain network connectivity, then the manufacturer must bear the expense of the subscription.

### SUMMARY

A vehicle includes a first communication channel administered by a vehicle manufacturer and a second communication channel administered by a vehicle owner. The vehicle further includes a controller programmed to transfer manufacturer data over the second communication channel, accumulate a count indicative of an amount of manufacturer data transferred over the second communication channel, generate an incentive amount based on the count, and, responsive to a redemption request, transfer the incentive amount for redemption.

The controller may be further programmed to communicate with a diagnostic tool and receive the redemption request from the diagnostic tool. The controller may be further programmed to establish a connection with a remote server and receive the redemption request from a remote server. The controller may be further programmed to, responsive to receiving an acknowledgment that the manufacturer data was transferred, generate a digital signature associated with the count and the incentive amount. The controller may be further programmed to generate the digital signature based on a vehicle identification number and a secret key. The controller may be further programmed to, responsive to receiving a status indicative of completion of the redemption, reset the count and the incentive amount. The controller may be further programmed to generate the incentive amount further based on a cost savings realized by transferring the manufacturer data over the second communication channel relative to transferring the manufacturer data over the first communication channel. The controller may be further programmed to generate the incentive amount based on time and location data. The controller may be further programmed to, responsive to the second communication channel being inaccessible for a predetermined time, transfer the manufacturer data over the first communication channel without accumulating the count. The incentive amount may be further based on a cost associated with the second communication channel at a time of transfer. The controller may be further programmed to receive, from a remote server after a transfer, a cost-savings amount and generate the incentive amount based on the cost-savings amount.

A method implemented by a vehicle controller includes transferring manufacturer data and user data over a communication channel administered by a vehicle owner and accumulating a count indicative of an amount of the manufacturer data transferred. The method further includes generating an incentive value based on the count and a cost savings associated with transferring the manufacturer data over the communication channel relative to transferring the manufacturer data over a manufacturer-administered communication channel.

The may further includes transferring the incentive value to an external device responsive to receiving a request to redeem the incentive value. The method may further include sending a notification to the vehicle owner responsive to transferring the incentive value. The method may further include storing the count partitioned by time and location with a signature that is based on a vehicle identification number, the count, and a secret key. The method may further include, responsive to the communication channel being inaccessible for a predetermined time, transferring the manufacturer data over the manufacturer-administered communication channel without accumulating the count.

A vehicle communication system includes a controller programmed to transfer manufacturer data and user data via a communication channel administered by a vehicle operator, accumulate a count indicative of an amount of manufacturer data transferred over the communication channel, and generate an incentive value based on the count and a cost savings associated with transferring the manufacturer data via the communication channel relative to transferring via a reserved channel administered by a vehicle manufacturer.

The controller may be further programmed to, responsive to the communication channel being inaccessible for a predetermined time, transfer the manufacturer data over the reserved channel without accumulating the count. The controller may be further programmed to generate the incentive value further based on a cost savings realized by transferring the manufacturer data over the communication channel relative to transferring the manufacturer data over the reserved channel. The controller may be further programmed to transfer the incentive value to an external system responsive to receiving a request to redeem the incentive value.

### BRIEF DESCRIPTION OF THE DRAWINGS

FIG. 1 is a possible configuration of a vehicle communication system.

FIG. 2 is a possible configuration of a system for managing an incentive-based communication system for communication of manufacturer-related data.

FIG. 3 is a block diagram of functions that may be implemented in a controller for a vehicle communication system.

FIG. 4 is a flow chart for a possible sequence of operations for monitoring data communications and generating an incentive amount.

FIG. 5 is a flow chart for a possible sequence of operations for transferring an incentive amount.

FIG. 6 is a flow chart for a possible sequence of operations for redeeming an incentive for goods or services.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Data analytics plays an increasing role in improving goods and services. Product manufacturers may stream data from the product to the cloud to collect information that may help to evaluate product quality. Data received from vehicles may help vehicle manufacturers to improve quality and services. For example, vehicle controllers may collect vehicle performance and diagnostic data. This information may be useful to the vehicle manufacturer to monitor performance and diagnose problems. For example, the data may provide feedback on the performance of various vehicle features and can be used to identify features that are not performing as expected. The data may also indicate the frequency of usage of various features and functions. The data may be used to design software updates to improve the performance of the identified features.

Vehicle manufacturers may provide a communication link within the vehicle for transferring vehicle data to remote computing systems. The vehicle manufacturer may absorb the cost for providing this communication link. Vehicle owners may utilize their own communication links. Vehicle manufacturers may benefit if they are permitted to utilize the vehicle owner communication links. Disclosed are systems and methods for providing incentives to vehicle owners to permit vehicle manufacturers to utilize the vehicle owner communication links.

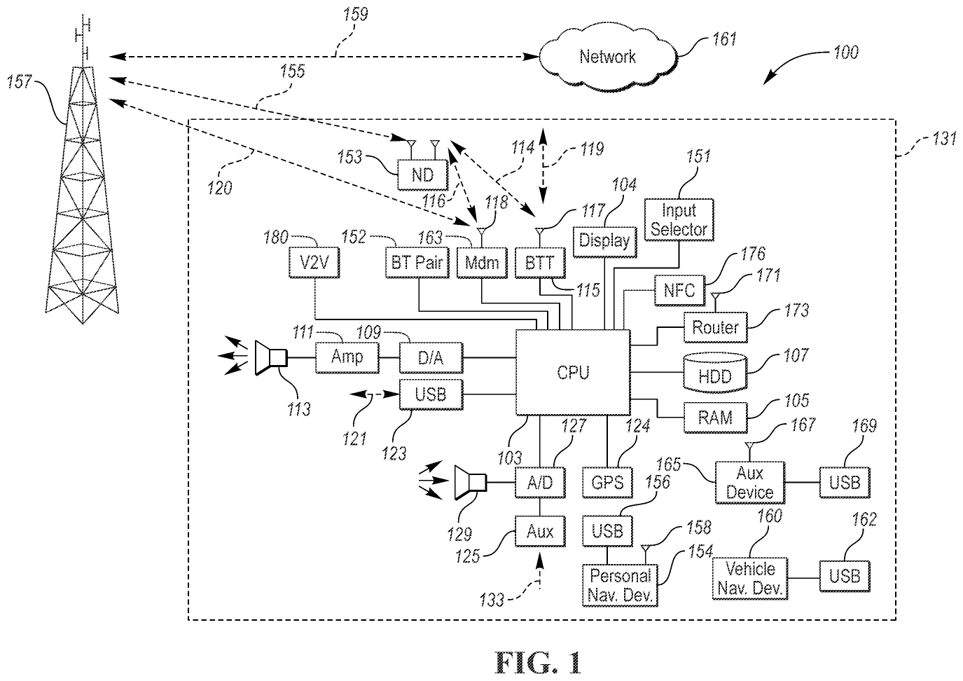

FIG. 1 illustrates an example block topology for a vehicle-based computing system 100 (VCS) for a vehicle 131. An example of such a vehicle-based computing system 100 is the SYNC system manufactured by THE FORD MOTOR COMPANY. The vehicle 131 enabled with the vehicle-based computing system 100 may contain a visual front-end interface 104 located in the vehicle 131. The user may be able to interact with the interface 104 if it is provided, for example, with a touch sensitive screen. In another illustrative embodiment, the interaction occurs through, button presses, spoken dialog system with automatic speech recognition and speech synthesis.

In the illustrative embodiment shown in FIG. 1, at least one controller 103 controls at least some portion of the operation of the vehicle-based computing system 100. The controller 103 may include one or more central processing units (CPU) that allows onboard processing of commands and routines. Further, the controller 103 may be connected to both non-persistent 105 and persistent storage 107. In this illustrative embodiment, the non-persistent storage 105 is random access memory (RAM) and the persistent storage 107 is a hard disk drive (HDD) or flash memory. Non-transitory memory may include both persistent memory and RAM. In general, persistent storage 107 may include all forms of memory that maintain data when a computer or other device is powered down. These include, but are not limited to, HDDs, CDs, DVDs, magnetic tapes, solid state drives, portable USB drives and any other suitable form of persistent memory.

The controller 103 may also include several different inputs allowing the user and external systems to interface with the controller 103. The vehicle-based computing system 100 may include a microphone 129, an auxiliary input port 125 (for input 133), a Universal Serial Bus (USB) input 123, a Global Positioning System (GPS) input 124, a screen 104, which may be a touchscreen display, and a Bluetooth input 115. The VCS 100 may further include an input selector 151 that is configured to allow a user to swap between various inputs. Input from both the microphone 129 and the auxiliary connector 125 may be converted from analog to digital by an analog-to-digital (A/D) converter 127 before being passed to the controller 103. Although not shown, numerous of the vehicle components and auxiliary components in communication with the VCS 100 may use a vehicle network (such as, but not limited to, a Controller Area Network (CAN) bus, a Local Interconnect Network (LIN) bus, a Media Oriented System Transport (MOST) bus, an Ethernet bus, or a FlexRay bus) to pass data to and from the VCS 100 (or components thereof).

Outputs from the controller 103 may include, but are not limited to, a visual display 104 and a speaker 113 or stereo system output. The speaker 113 may be connected to an amplifier 111 and receive its signal from the controller 103 through a digital-to-analog (D/A) converter 109. Outputs can also be made to a remote Bluetooth device such as a Personal Navigation Device (PND) 154 or a USB device such as vehicle navigation device 160 along the bi-directional data streams shown at 119 and 121 respectively.

In one illustrative embodiment, the system 100 uses the Bluetooth transceiver 115 with an antenna 117 to communicate with a user's nomadic device 153 (e.g., cell phone, smart phone, Personal Digital Assistance (PDA), or any other device having wireless remote network connectivity). The nomadic device 153 can then be used to communicate over a tower-network communication path 159 with a network 161 outside the vehicle 131 through, for example, a device-tower communication path 155 with a cellular tower 157. In some embodiments, tower 157 may be a wireless Ethernet or WiFi access point as defined by Institute of Electrical and Electronics Engineers (IEEE) 802.11 family of standards. Exemplary communication between the nomadic device 153 and the Bluetooth transceiver 115 is represented by Bluetooth signal path 114.

Pairing the nomadic device 153 and the Bluetooth transceiver 115 can be instructed through a button 152 or similar input. Accordingly, the controller 103 is instructed that the onboard Bluetooth transceiver 115 will be paired with a Bluetooth transceiver in a nomadic device 153.

Data may be communicated between the controller 103 and the network 161 utilizing, for example, a data-plan, data over voice, or Dual Tone Multi Frequency (DTMF) tones associated with nomadic device 153. Alternatively, it may be desirable to include an onboard modem 163 having antenna 118 in order to establish a vehicle-device communication path 116 for communicating data between the controller 103 and the network 161 over the voice band. The nomadic device 153 can then be used to communicate over the tower-network communication path 159 with a network 161 outside the vehicle 131 through, for example, device-tower communication path 155 with a cellular tower 157. In some embodiments, the modem 163 may establish a vehicle-tower communication path 120 directly with the tower 157 for communicating with network 161. As a non-limiting example, modem 163 may be a USB cellular modem and vehicle-tower communication path 120 may be cellular communication.

In one illustrative embodiment, the controller 103 is provided with an operating system including an application programming interface (API) to communicate with modem application software. The modem application software may access an embedded module or firmware on the Bluetooth transceiver 115 to complete wireless communication with a remote Bluetooth transceiver (such as that found in a nomadic device 153). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 153 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all International Telegraph Union (ITU) International Mobile Telecommunication (IMT) 2000 (3G) compliant standards and offer data rates up to 2 Mbps for stationary or walking users and 385 Kbps for users in a moving vehicle. 3G standards are now being replaced by IMT-Advanced (4G) which offers 100 Mbps for users in a vehicle and 1 Gbps for stationary users. If the user has a data-plan associated with the nomadic device 153, it is possible that the data-plan allows for broad-band transmission and the system could use a much wider bandwidth (speeding up data transfer). In still another embodiment, communication functions associated with the nomadic device 153 may be replaced using a cellular communication device (not shown) that is installed to vehicle 131. In yet another embodiment, the nomadic device 153 may be a wireless local area network (LAN) device capable of communication over, for example (and without limitation), an IEEE 802.11g network (i.e., WiFi) or a WiMax network.

In one embodiment, incoming data can be passed through the nomadic device 153 via a data-over-voice or data-plan, through the onboard Bluetooth transceiver 115 and to the controller 103. In the case of certain temporary data, for example, the data can be stored on the HDD or other storage media 107 until the data is no longer needed.

Additional sources that may interface with the vehicle 131 include a personal navigation device 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the controller 103 may be in communication with a variety of other auxiliary devices 165. The auxiliary devices 165 can be connected through a wireless (e.g., via auxiliary device antenna 167) or wired (e.g., auxiliary device USB 169) connection. Auxiliary devices 165 may include, but are not limited to, personal media players, wireless health devices, portable computers, and the like.

The controller 103 may be connected to one or more Near Field Communication (NFC) transceivers 176. The NFC transceivers 176 may be configured to establish communication with compatible devices that are in proximity to the NFC transceivers 176. The NFC communication protocol may be useful for identifying compatible nomadic devices that are proximate the NFC transceivers 176.

Also, or alternatively, the controller 103 may be connected to a vehicle-based wireless router 173, using for example a WiFi (IEEE 802.11) transceiver/antenna 171. This may allow the controller 103 to connect to remote networks in range of the local router 173. In some configurations, the router 173 and the modem 163 may be combined as an integrated unit. However, features to be described herein may be applicable to configurations in which the modules are separate or integrated.

The controller 103 may interface to a vehicle-to-vehicle (V2V) communication system 180 or transceiver. The V2V communication system 180 may be a Dedicated Short-Range Communication (DSRC) system configured to transmit and receive messages directly between vehicles and infrastructure devices when within a predetermined range of one another. The V2V communication system 180 may implement established communication protocols.

In addition to having exemplary processes executed by a vehicle computing system 100 located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

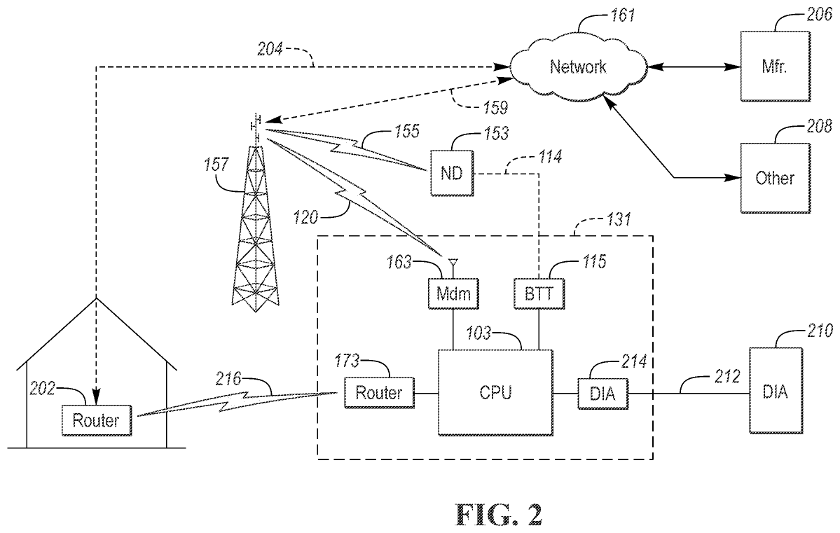

FIG. 2 depicts a possible configuration for a vehicle communications system for managing an incentive-based communication system for communicating manufacturer-related data over a selected communication path. The vehicle 131 may be configured to transfer manufacturer-related data and information via the onboard cellular modem 163 through the vehicle-tower communication path 120 directly with the tower 157. For example, the vehicle-tower communication path 120 (also referred to as the vehicle cellular communication channel) may be a cellular communication data path that is administered by the vehicle manufacturer. Communication via the vehicle-tower communication path 120 may require a subscription with a cellular carrier.

The vehicle cellular communication channel 120 may also be used to transfer information and data for the vehicle operator. For example, onboard navigation and infotainment systems may also transfer data over the vehicle cellular communication channel 120. In some cases, the vehicle owner may find it desirable to subscribe to the vehicle cellular communication channel 120 and pay any associated fees. As the vehicle manufacturer may be using some of the bandwidth, the manufacturer may subsidize a portion of the subscription fees. However, the vehicle owner may opt to cancel the subscription with the cellular carrier associated with the vehicle cellular communication channel 120. In this case, if the vehicle manufacturer wants to maintain communication capability via the vehicle cellular communication channel 120, the vehicle manufacturer may be responsible for the entire subscription fee. To ensure the transfer of vehicle data, the vehicle manufacturer may opt to administer the vehicle cellular communication channel 120. Administration of a communication path or channel may include selecting the carrier, plan, features, capabilities, and cost associated with the communication channel. The vehicle manufacturer may fund/finance the vehicle cellular communication channel 120. As such, the vehicle manufacturer may incur a cost for transferring data from the vehicle via this communication channel. Depending on the subscription, the cost may be a fixed amount or may vary based on the amount of data transferred. The vehicle manufacturer may be interested in maintaining the connectivity as the value of the data to the manufacturer may exceed the cost of the connectivity. In addition, having a manufacturer-administered communication channel may allow for more reliable over-the-air software updates.

In addition to the vehicle-manufacturer administered channel, other communication channels may be available. For example, the vehicle 131 may connect to the network 161 by connecting to the user-provided nomadic device 153. For example, the vehicle 131 may establish a Bluetooth connection between the Bluetooth transceiver 115 and the user-provided nomadic device 153. In some configurations, the nomadic device 153 may be plugged into a USB port (e.g., 123) and communicate with the vehicle over a USB channel (e.g., 121). The user-provided nomadic device 153 may connect to the network 161 via the device-tower communication path 155.

In addition, or in the alternative, the vehicle 131 may communicate over a wireless network via the router 173. The vehicle router 173 may establish a wireless network communication channel 216 with an external router 202. For example, the external router 202 may be located at the home of the vehicle owner. The external router 202 may be connected to the network 161 by a home router-to-network communication path 204. The external router 202 may be configured to access the internet and devices connected to a home network. Some setup may be required by the vehicle owner for the vehicle router 173 to establish a connection via the wireless communication channel 216. For example, the vehicle owner may configure the controller 103 to access the home network by entering passcodes or other security measures. However, if the vehicle owner does not set up the connection, the vehicle 131 may be unable to transfer data over via the external router 202. In some situations, the vehicle 131 may be parked out of range of the external router 202 for a period of time (e.g., vacation) so that the vehicle 131 may be unable to connect to wireless network communication channel 216.

The controller 103 may be programmed to collect manufacturer-related data from various vehicle subsystems. Manufacturer-related data may be any vehicle data or information that is desired by the manufacturer. The data may include performance and diagnostic data from other controllers and systems. The controller 103 may communicate over the vehicle network to obtain the information. The controller 103 may be configured to collect the data immediately prior to sending to the manufacturer. In some configurations, the controller 103 may be configured to maintain a log file of data that can be transferred later. The log file may be stored in non-volatile memory for later transmission. It may be desired to periodically send the log file so that the log file does not consume excessive memory resources. The log file may also be sent when the storage or memory is full.

The vehicle 131 may include a diagnostic interface 214 for interfacing to a diagnostic tool 210. The diagnostic interface 214 may define a diagnostics communication channel 212. In some configurations, the diagnostics communication channel 212 may be an extension of the vehicle network. The diagnostic interface 214 may include a connector or receptacle that is configured to receive a mating connection that is tethered to the diagnostic tool 210. The controller 103 may be programmed to implement a diagnostics protocol. The controller 103 may be configured to respond to requests from the diagnostics tool 210 according the to the diagnostics protocol.

Many vehicle owners may have a nomadic device 153 such as a cellular phone. In addition, many vehicle owners may have a wireless Ethernet network at home for connecting to the Internet. These communication connections may be administered by the vehicle owner. The vehicle owner is responsible for selecting, managing, and paying for these communication channels. In some cases, there may be no limits to the amount of data that may be transferred over the associated network (e.g., cellular, Ethernet). The communication channels may be used to transfer manufacturer data and user data. As the vehicle manufacturer must likely pay to maintain the vehicle cellular communication channel 120, it may be beneficial to provide incentives for the vehicle owner to allow the vehicle manufacturer data to be transferred via the vehicle-owner-administrated networks. The vehicle owner may decide whether to participate or not. The direct cost of the vehicle cellular communication channel 120 to the manufacturer may be reduced if the vehicle data can be transferred via the nomadic device 153 or the external router 202. For example, the vehicle cellular communication channel 120 that is funded by the vehicle manufacturer (e.g., cellular communication channel 120) may be a metered connection in which the cost varies with the amount of data transferred. By reducing the amount of data transferred over vehicle cellular communication channel 120, the cost to the manufacturer may be reduced. A vehicle communication system that offers incentives to the vehicle owner to allow manufacturer-related data to be transferred over owner-administrated communication channels may provide benefits to both the vehicle owner and the vehicle manufacturer.

A manufacturer server 206 may be connected to the network 161 and communication between the controller 103 and the manufacturer server 206 may be established. Other servers 208 may be connected to the network 161 and communication may be established between the manufacturer server 206 and the other servers 208. The other servers 208 may include dealership and third-party business servers. The other servers 208 may be operated by those businesses that participate in the incentive program. When incentives are redeemed, the manufacturer server 206 may communicate with the other servers 208 to facilitate the transaction.

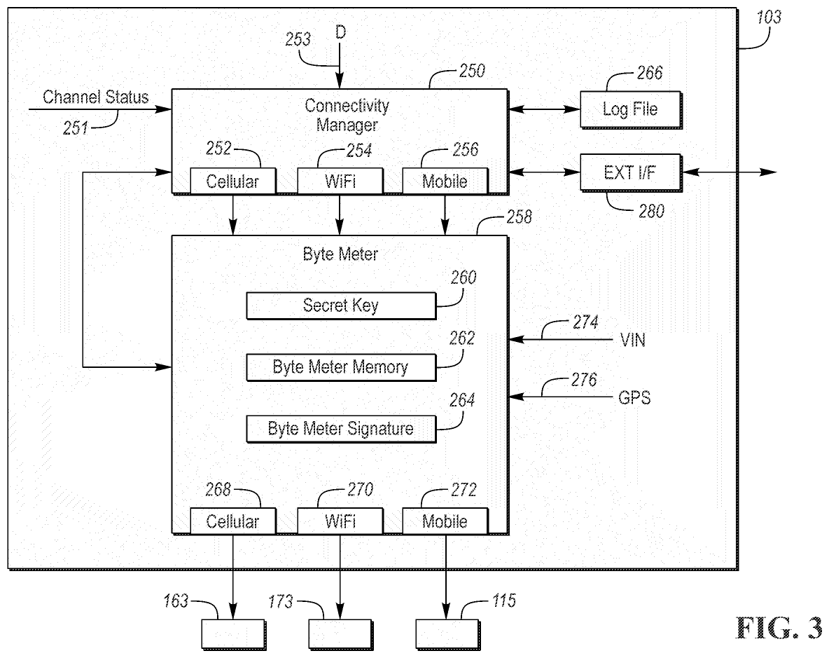

FIG. 3 depicts a block diagram of functions and/or features that may be implemented in the controller 103. The controller 103 may be programmed to implement a connectivity manager 250 and a byte meter process 258. The connectivity manager 250 may be configured to manage the transfer of manufacturer data over multiple paths, separately and/or simultaneously. The connectivity manager 250 may determine when manufacturer data is to be transferred. The connectivity manager 250 may receive input data D 253 from other processes. The connectivity manager 250 may also query other processes to request transfer of the input data D 253. The connectivity manager 250 may determine whether input data D 253 is stored in the log file 266 or immediately transferred for transmission.

The connectivity manager 250 may receive channel status data 251 for each supported communication channel. The channel status data 251 may include a signal indicative of the present availability of each of the communication channels. The channel status data 251 may include data indicative of a data transfer rate for each of the communication channels. The connectivity manager 250 may select a channel for transferring data based on transfer speed and availability. The connectivity manager 250 may allocate data for transfer among the available communication channels. The connectivity manager 250 may select from a cellular output channel 252, a WiFi output channel 254, and/or a mobile output channel 256. The cellular output channel 252 may be a vehicle manufacturer-administered channel. The WiFi output channel 254 may be a wireless Ethernet channel. The mobile output channel 256 may be via a link to a mobile device of the vehicle owner. The WiFi output channel 254 and the mobile output channel 256 may be vehicle owner-administered communication channels. The channels described may represent buffers of data for transfer to the byte meter process 258.

Data destined for each of the communication channels may be transferred to the byte meter process 258 that is configured to count data that is transferred through each channel. The count may be a count of the number of bytes that are transferred over each of the channels. The byte meter process 258 may include memory storage and processing functions for a secret key 260. The data may be encrypted using the secret key 260 information so that the data may not be accessed without the proper decryption algorithm and keys. The secret key 260 may be used to ensure security of data stored within the byte meter process 258. The secret key 260 may be defined by manufacturer based on an encryption process that is utilized. The byte meter process 258 may receive GPS data 276 that is indicative of a present location of the vehicle 131. The GPS data 276 may be shared with the connectivity manager 250 and may be used to learn the location of communication channels.

The byte meter process 258 may include a byte meter memory 262 storage area for preserving variables and data associated with the byte meter process 258.

TABLE 1
Example of Byte Memory Meter Contents.

| Time | WiFi | Cellular | Mobile |
|---|---|---|---|
| −3 GMT | 0 | 3 | 0 |
| −2 GMT | 20 | 32 | 0 |
| −1 GMT | 0 | 46 | 10 |
| 0 GMT | 130 | 145 | 86 |
| 1 GMT | 0 | 76 | 0 |

Table 1 depicts an example of the organization and contents of the byte meter memory 262. For example, each row may represent a time interval. Each column may represent one of the communication channels. The contents of each cell may represent a number of bytes transferred during the given time interval over the given communication channel. Note that additional communication channels may be present. The table may also include more time intervals than depicted.

The byte meter process 258 may include a byte meter signature 264 function that is configured to generate a digital signature for the data. The signature may be generated based on the cells of the byte meter memory 262 and a vehicle identification number (VIN) 274 that is received. The digital signature may be saved within the byte meter process 258 for later use. The signature may be included in certain transmissions from the controller 103. The receiver of the data may recreate the digital signature and compare it to the received signature to verify that the received data is accurate.

The data may be transferred via the chosen communication channel. Data received from the cellular output channel 252 may be routed to the cellular modem 163 via a cellular output interface 268. Data received from the WiFi output channel 254 may be transferred to the router 173 via a WiFi output interface 270. Data received from the mobile output channel 256 may be transferred to the Bluetooth interface 115 via a mobile output interface 272. The interfaces may manage the transfer of data over the associated communication path.

The communication paths may include manufacturer-administrated communication channels (e.g., cellular communication channel 120) and vehicle owner-administrated channels (e.g., device-tower communication path 155, wireless communication channel 216). The byte meter process 258 may maintain a count of data-bytes transferred via each communication channel. The byte meter process 258 may track the amount (e.g., number of bytes) of manufacturer-related data transferred over the vehicle-owner-administrated channels. When manufacturer-related data is transferred over the owner-administrated channels, the manufacturer may provide an incentive to the owner for providing the communication channel for the data transfer. The incentive value may be tracked and accessible in a user account. For example, the incentive may be in the form of a discount or credit for expenses at an associated dealership (e.g., for service, aftermarket products) or participating third-party businesses.

The vehicle owner may be required to establish a user account. The user account may be linked to the vehicle identification number (VIN) that is unique to each vehicle. The user account may be accessible by the vehicle owner using a web browser and/or a nomadic device application. The user account may be maintained on the manufacturer server 206 that is connected to the network 161. The user account may provide access to the incentive value and/or associated data. For example, the user account interface may include selections for applying the incentive value to purchases. The system may define a registration process that facilitates the vehicle owner registering for the service. The registration process may include linking the vehicle identification number (VIN) to the owner account. The owner may link multiple VINs to the account. Once registered, the vehicle owner may monitor the incentive amounts by logging into a website. In other configurations, the vehicle owner may access the incentive amount via an application executed on the nomadic device 153.

For example, the controller 103 may implement an external interface function 280 that is configured to exchange data with other modules within the vehicle and external to the vehicle. The external interface 280 may receive the incentive value and associated data from the manufacturer server 206. The data may be transferred to the connectivity manager 250 and/or byte meter process 258 for storage and/or processing. The external interface function 280 may also receive configuration information for configuring the connectivity manager 250. The external interface function 280 may also provide data from the connectivity manager 250 and the byte meter process 258 to other modules in the vehicle 131 (e.g., display 104). The connectivity manager 250 and the byte meter process 258 may exchange data with one another.

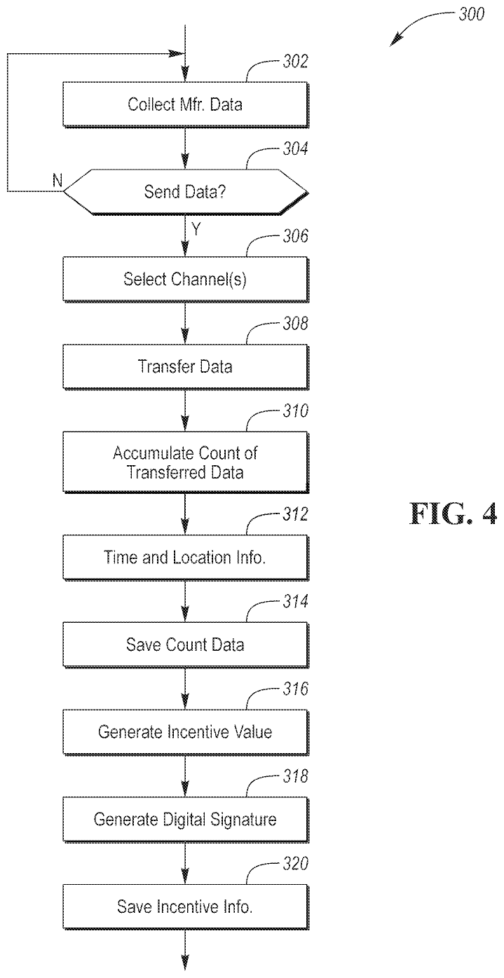

FIG. 4 depicts a flowchart 300 for a process including a sequence of operations that may be implemented as part of the vehicle communication system. At operation 302, the process may be configured to collect manufacturer data. For example, the connectivity manager 250 may be configured to retrieve or receive data from other modules. The collected data may be stored in the log file 266. This process may be performed continually while the vehicle 131 is operating. At operation 304, a check may be performed to determine if manufacturer data should be sent. Various parameters may be checked to determine if the manufacturer data should be sent. For example, the log file 266 exceeding a predetermined size may trigger the transmission of data. The controller 103 may determine the priority of the data to be transferred. High priority data may be tagged for immediate transmission. Low priority data may be stored and tagged for later transmission. The priority of the data may be used to determine whether the data can be stored in the log file 266 for later transmission. High priority data may be transferred over any available channel regardless of other factors. Data that is of high priority may trigger an immediate transmission of the data. If there is no data ready to be transferred, operation 302 may be repeated.

If data is to be sent, operation 306 may be performed. At operation 306, the process may be configured to execute instructions to select the communication channel over which to transfer the data. The controller 103 may establish a direct cellular network connection (e.g., path 120), a WiFi connection (e.g., via router 173), and a cellular path (e.g., 155) via the owner nomadic device 153. The vehicle communication system may establish a connection to the manufacturer server 206 via the cloud or network 161 via one or more of these paths. The connectivity manager 250 may manage the transfer of manufacturer data over each of the paths. For example, the connectivity manager 250 may select the communication channel or channels over which to transfer data. The connectivity manager 250 may further select the channel based on channel availability, amount of data to transfer, channel transfer rate, transfer cost, and priority of the data transfer. The connectivity manager 250 may prioritize transferring manufacturer-related data over the owner-administrated communication channels. For example, the wireless network channel 216 may be highest priority while, the manufacturer-administrated cellular channel 120 may be the lowest priority. Prioritization may also be determined based on transfer speed and/or transfer cost.

The connectivity manager 250 may select the communication channel based on cost. The connectivity manager 250 may monitor the cost and select the channel with the lowest cost. The connectivity manager 250 may schedule data transfers at times at which the cost is lowest. For example, a vehicle data log file 266 may be scheduled to be transferred during off-peak times when costs may be lowest. The connectivity manager 250 may receive cost data from the manufacturer server 206. As the cost data may periodically change, the cost data may be downloadable. In other configurations, the manufacturer server 206 may compile a table of prioritized transmission times and locations and provide the table to the connectivity manager 250.

While the connectivity manager 250 may prioritize transfers over the owner-administered communication channels, situations may arise in which these channels are not available or accessible. The controller 103 may be programmed to, responsive to the owner-administrated communication channels being inaccessible for a predetermined time, transfer the manufacturer data over the manufacturer-administered communication channel. The manufacturer-administered communication channel may be referred to as a reserved communication channel as it may be reserved for communication when the owner-administered channels are not available. Data sent via the manufacturer-administered communication channel may be counted but may not be included in the incentive calculation.

After selecting the channel(s) to transfer the data, the controller 103 may be programmed to transfer the data via the selected channel at operation 308. The data may be transferred via the byte meter process 258 which may count the data before transmission. The controller 103 may implement various communication protocols to transfer the data via the selected channel. Data may be transferred in multiple frames or in a single frame depending on the protocol for the selected channel. The controller 103 may ensure that the data is successfully transferred by receiving and interpreting acknowledgment messages. The controller 103 may be programmed to handle any signal/message handshaking that are required of the specific protocol.

At operation 310, the process may include executing instructions to accumulate a count indicative of an amount of manufacturer data that is transferred. The count may be the number of bytes that are transferred. To determine an incentive value, the controller 103 may be further programmed to determine the amount of manufacturer data that is transferred over each channel. The byte meter process 258 may be configured to accumulate a count of the number of bytes that are transferred over each communication channel. The data may be accumulated within predetermined time intervals. Data transferred via the manufacturer-administered communication channel may be counted but may not be factored into the incentive value.

At operation 312, the process may be configured to receive time and location data. For example, time and location information may be obtained from the GPS module (FIG. 1, 124). The connectivity manager 250 may be configured to track the data transfers based on a time of day. The cost to transfer data over some communication channels may vary with the time of day. Communication carriers may charge less for data transfers that occur during less busy times of the day. For example, data transfer costs may be lower late at night when less communication network bandwidth is being utilized.

The count may be further accumulated and partitioned based on time of day. For example, the byte meter process 258 may maintain an array with indices of time of day and communication channel as described in relation to Table 1 above. The byte meter process 258 may increment the appropriate count value based on the present time and the communication channel being used. The byte meter process 258 may be configured to count only manufacturer data that is transferred. Data that is determined to be for the vehicle owner may not be included in the count. The process may be further configured to monitor a location at which each data transfer is made. For example, the byte meter process 258 may sample GPS data 276 during a data transfer and associate the location with the transfer. This may be useful as transfer rates may vary with location. In addition, the GPS location 276 may be linked to wireless network access. The connectivity manager 250 may use the location data for scheduling data transfers based on location. For example, when the location matches a stored location for a wireless network, the connectivity manager 250 may attempt to establish a connection with the wireless network for transferring data.

At operation 314, the controller 103 may execute instructions to save the count data. Count data may be stored in non-volatile memory and may be partitioned by communication channel, time, and location information. The saved count data may provide a basis for predicting future data transfers.

The controller 103 may be programmed to receive an acknowledgment from the manufacturer server 206 that the data was transferred successfully. In some configurations, the acknowledgment may be used to trigger saving the count data. The controller 103 may be programmed to receive cost information from the manufacturer server 206. For example, the manufacturer server 206 may generate a cost-savings value associated with the transfer and send the information to the controller 103 via one of the communication channels.

At operation 316, the controller 103 may execute instructions to generate an incentive value. For example, the controller 103 may process the count data to determine a cost of the manufacturer-related data that is transferred. Cost may be affected by the count, the communication channel and the time of day of the transfer. The incentive amount may be further based on a cost savings realized by transferring the manufacturer data over the owner-administrated communication channels relative to transferring the manufacturer data over the manufacturer-administered communication channel. The cost savings value may be generated by the controller 103 and/or may be received from the manufacturer server 206. The incentive amount may be based on a cost associated with the owner-administered communication channel at the time of the data transfer.

In some configurations, the process may be configured to send the saved count data to a remote server (e.g., 206). The connectivity manager 250 may also send data that indicates which communication channel from the vehicle was used. For example, the data that is transferred may be tagged with a channel identifier to indicate which channels were used. An application or program that is executed on the manufacturer server 206 may determine a total cost associated with the data transfers. The total cost may be dependent upon the channel used and the time of day. The total cost may be dependent upon the cost associated with transferring the same amount of data over the manufacturer-administered channel. The total cost may be converted to an incentive amount. The incentive amount may be transferred to the connectivity manager 250 for retention in the vehicle. The incentive amount may also be linked to the user account.

The controller 103 may represent the incentive value in a number of ways. The incentive value may be an accumulated value that changes as data is transferred. In some configurations, the incentive value may be stored as incremental amounts that represent the incentive earned over predetermined periods of time. The total incentive value may be a sum of the incremental values. In some configurations, incentive values may be represented in terms of currency. In some configurations, the incentive values may be represented as points that are convertible into units of currency.

The vehicle communication system may be further configured to include security measures for incentive data and data transfers. At operation 318, the controller 103 may execute instructions (e.g., byte meter signature function 264) to generate a digital signature for the incentive data. For example, the incentive data may be encrypted using the secret key 260 so that the data may not be accessed without the proper decryption algorithm and keys. This is to prevent a person from altering the data to increase any incentive amounts or apply the incentive amounts to other vehicles or accounts. The signature may be derived by a sequence of operations performed on the incentive data set and VIN using the security key. As an example, the incentive data and the VIN may be processed by a signature function 264 using the secret key. The data may be decrypted by another process or machine having knowledge of the secret key and encryption algorithm. The decryption may be known by only the manufacturer server 206.

At operation 320, the incentive information, including the digital signature, may be stored in non-volatile memory for later retrieval. In some configurations, the incentive information may be communicated to the manufacturer server 206 via one of the communication channels. The incentive information may then be linked to the owner account and the incentive status may be available by accessing the vehicle owner account.

The incentive value may be available for display on an in-vehicle display 104. For example, a touch-screen display may present a menu structure with a selection for viewing the present incentive value. The incentive value may be transferred over the vehicle network to the display 104 when requested.

The connectivity manager 250 monitors the amount of data transferred via the owner-administered communication channels. The manufacturer may compensate the owner for use of the owner-administered communication channels. For example, usage of the owner-administered communication channels reduces the usage of the manufacturer-administered communication channels. The system and methods described allow the manufacturer to compensate the vehicle owners for using communication channels that the owner maintains and funds. Further, the incentives may be structured to provide discounts to the owner for vehicle-related purchases. For example, the incentives may be used for discounts on service visits at authorized service shops. The incentives may also be used for discounts or products that may be purchased by the owner. For example, the owner may be directed to a website that offers for sale various manufacturer-related accessories and/or services. For the manufacturer, the system may result in similar or reduced costs. The vehicle owner may realize benefits as the incentives have some actual monetary value. Such incentives may improve owner satisfaction resulting in a higher propensity to make further purchases from the manufacturer. The incentive program may be applied to any third-parties and may apply to non-automotive purchases as well. For example, the incentive amount could be applied to the cellular communication bill of the vehicle owner.

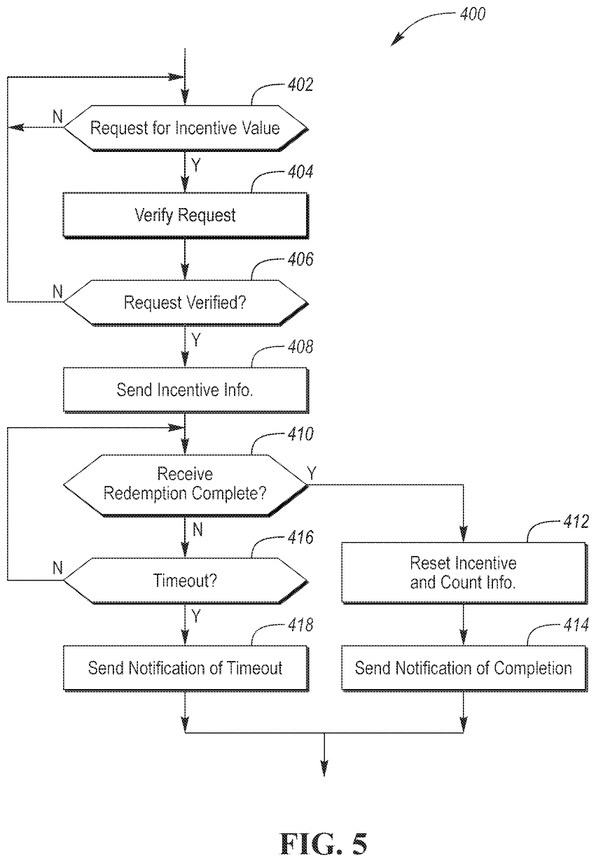

FIG. 5 depicts a possible flow chart 400 for retrieving the incentive value from the vehicle. At operation 402, the controller 103 monitors if a request has been received for the incentive value. The request for the incentive value may be received in several ways. In some configurations, the vehicle owner may visit a participating location or facility that is registered to redeem the incentive. The facility operator may read the incentive information with the diagnostic tool 210. In some configurations, a request may be generated from the diagnostic tool 210 that is connected to the diagnostic interface 214. In some configurations, the redemption request may be received over one the communication channels. For example, redeeming the incentive for an on-line purchase.

If the redemption request is received, operation 404 may be performed. At operation 404, the controller 103 may execute instructions to verify that the request is legitimate. The request may include information configured to ensure that the request is legitimate. The request may include a key that is indicative of some combination of the VIN and the owner account. Authorized sources of the request (e.g., diagnostic tool, manufacturer server) may properly construct the key, while unauthorized sources may not have this knowledge. The process may require that the controller 103 be placed in a particular operating mode (e.g., diagnostic mode, incentive retrieval mode) before the incentive data may be accessed.

At operation 406, if the request is not verified, then execution may return to operation 402 to wait for another request. The owner may be notified of the denied request. If the request is verified, operation 408 may be performed. At operation 408, the controller 103 may execute instructions to send the incentive data. The incentive data may be sent via the communication channel over which the redemption request was received. The incentive data may include the digital signature.

At operation 410, the controller 103 may check to determine if a redemption complete status is received. The redemption complete status may be indicative of the incentive having been successfully redeemed and processed. The redemption complete status may include an amount of the incentive that has been redeemed in the case of a partial redemption. If the redemption complete status is not received, operation 416 may be performed to check for a timeout. The controller 103 may wait for a predetermined time for a redemption complete status. While the timeout period has not expired, operations 410 and 416 may be repeated. If the timeout period has expired, operation 418 may be performed. At operation 418, the controller 103 may transmit a notification of the timeout condition. The notification may be sent via the communication channel over which the redemption request was received. The notification may be sent to the vehicle owner over a predetermined communication channel as an email, text message, voice message, or other alert.

If the redemption complete status is received before the timeout period expires, operation 412 may be performed. At operation 412, the incentive information and the count information may be reset. For example, after the incentive value is fully redeemed, the incentive value may be reset to zero. In cases in which the incentive value is partially redeemed, the incentive value may be adjusted to the unused incentive amount. The system may then start accumulating the value again. At operation 414, a notification may be sent that indicates that the incentive was redeemed successfully. For example, a message may be sent to the vehicle owner over a predetermined communication channel.

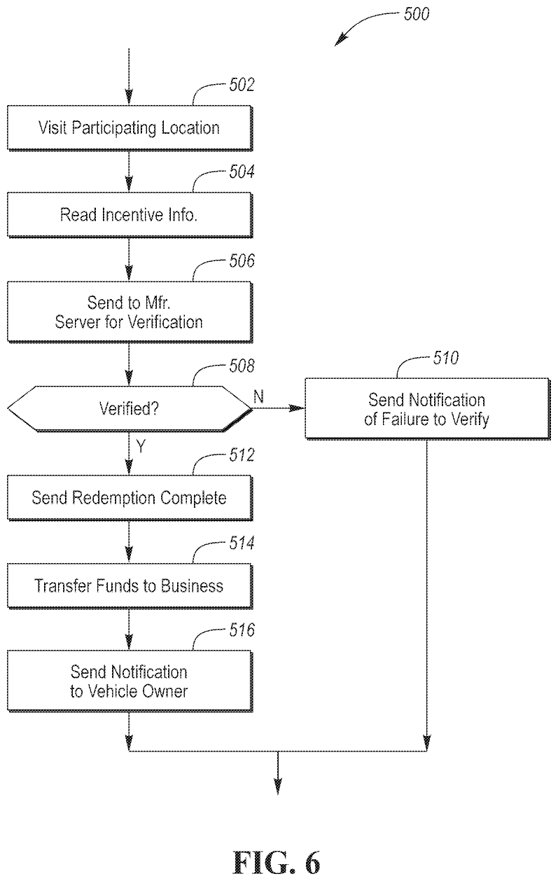

FIG. 6 depicts a flow chart 500 for the overall process of redeeming an incentive. At operation 502, the vehicle owner may visit a participating location. The location may be a physical location or may be an authorized website. At operation 502, the incentive value may be read from the vehicle 131. The incentive value may be read by connecting the diagnostic tool 210 and sending the appropriate commands to the vehicle 131. The incentive value may be read by sending commands to the vehicle 131 via the manufacturer server 206.

At operation 506, the incentive information may be received and sent to the manufacturer server 206 for verification and processing. At operation 508, the request may be verified by the manufacturer server 206 to determine if the incentive information is legitimate. The verification may include decrypting the incentive information using the keys and decryption algorithm. The incentive information may be further compared to the information that is associated with the vehicle owner account to determine if the data matches. If the request fails the verification, then operation 510 may be performed to send a notification of the verification failure. The notification may be sent to the sender of the redemption request and to the vehicle owner.

If the request is verified, operation 512 may be performed. At operation 512, a signal indicative of completion of the redemption (e.g., a redemption complete status) may be sent to the vehicle 131 for resetting the incentive information. The redemption complete status may be transferred through the diagnostic tool 210 and/or may be sent directly to the vehicle 131. At operation 514, funds may be transferred to an account associated with the participating location. The amount of funds transferred may correlate to the processed incentive amount. At operation 516, a notification may be sent to the vehicle owner indicating the discount has been applied. The notification may be sent as an email, a text message, and/or a status in an application.

The system and methods described provide increased value to the vehicle owner. Further, the system and methods may improve brand loyalty by providing discounts and incentives to use the manufacturers services. The system provides benefits for both the vehicle manufacturer and vehicle owner. The costs to the vehicle manufacturer may not change dramatically but customer satisfaction may increase as vehicle owners now receive the payments. The vehicle owner may receive incentives of monetary value by merely allowing usage of communication channels that may have little incremental cost associated with handling the vehicle data transfers.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a first communication channel administered by a vehicle manufacturer;
a second communication channel administered by a vehicle owner; and
a controller programmed to transfer manufacturer data over the second communication channel, accumulate a count indicative of an amount of manufacturer data transferred over the second communication channel, generate an incentive amount based on the count, and, responsive to a redemption request, transfer the incentive amount for redemption.

2. The vehicle of claim 1 wherein the controller is further programmed to communicate with a diagnostic tool and receive the redemption request from the diagnostic tool.

3. The vehicle of claim 1 wherein the controller is further programmed to establish a connection with a remote server and receive the redemption request from a remote server.

4. The vehicle of claim 1 wherein the controller is further programmed to, responsive to receiving an acknowledgment that the manufacturer data was transferred, generate a digital signature associated with the count and the incentive amount.

5. The vehicle of claim 4 wherein the controller is further programmed to generate the digital signature based on a vehicle identification number and a secret key.

6. The vehicle of claim 1 wherein the controller is further programmed to, responsive to receiving a status indicative of completion of the redemption, reset the count and the incentive amount.

7. The vehicle of claim 1 wherein the controller is programmed to generate the incentive amount further based on a cost savings realized by transferring the manufacturer data over the second communication channel relative to transferring the manufacturer data over the first communication channel.

8. The vehicle of claim 1 wherein the controller is further programmed to generate the incentive amount based on time and location data.

9. The vehicle of claim 1 wherein the controller is further programmed to, responsive to the second communication channel being inaccessible for a predetermined time, transfer the manufacturer data over the first communication channel without accumulating the count.

10. The vehicle of claim 1 wherein the incentive amount is further based on a cost associated with the second communication channel at a time of transfer.

11. The vehicle of claim 1 wherein the controller is further programmed to receive, from a remote server after a transfer, a cost-savings amount and generate the incentive amount based on the cost-savings amount.

12. A method comprising:
by a vehicle controller,
transferring manufacturer data and user data over a communication channel administered by a vehicle owner;
accumulating a count indicative of an amount of the manufacturer data transferred; and
generating an incentive value based on the count and a cost savings associated with transferring the manufacturer data over the communication channel relative to transferring the manufacturer data over a manufacturer-administered communication channel.

13. The method of claim 12 further comprising, by the vehicle controller, transferring the incentive value to an external device responsive to receiving a request to redeem the incentive value.

14. The method of claim 13 further comprising, by the vehicle controller, sending a notification to the vehicle owner responsive to transferring the incentive value.

15. The method of claim 12 further comprising, by the vehicle controller, storing the count partitioned by time and location with a signature that is based on a vehicle identification number, the count, and a secret key.

16. The method of claim 12 further comprising, by the vehicle controller, responsive to the communication channel being inaccessible for a predetermined time, transferring the manufacturer data over the manufacturer-administered communication channel without accumulating the count.

17. A vehicle communication system comprising:
a controller programmed to transfer manufacturer data and user data via a communication channel administered by a vehicle operator, accumulate a count indicative of an amount of manufacturer data transferred over the communication channel, and generate an incentive value based on the count and a cost savings associated with transferring the manufacturer data via the communication channel relative to transferring via a reserved channel administered by a vehicle manufacturer.

18. The vehicle communication system of claim 17 wherein the controller is further programmed to, responsive to the communication channel being inaccessible for a predetermined time, transfer the manufacturer data over the reserved channel without accumulating the count.

19. The vehicle communication system of claim 17 wherein the controller is further programmed to generate the incentive value further based on a cost savings realized by transferring the manufacturer data over the communication channel relative to transferring the manufacturer data over the reserved channel.

20. The vehicle communication system of claim 17 wherein the controller is further programmed to transfer the incentive value to an external system responsive to receiving a request to redeem the incentive value.
